(19) United States
(12) Patent Application Publication
(10) Pub. No.: US 2011/0227546 A1
(43) Pub. Date: Sep. 22, 2011

(54) DC-DC CONVERTER

(75) Inventors: Kimihiro Nishijima, Oita (JP); Kosuke Abe, Kanagawa (JP)

(73) Assignees: OITA University, Oita (JP); Hitachi Computer Peripherals Co., Ltd., Kanagawa (JP)

(21) Appl. No.: 13/129,665

(22) PCT Filed: Oct. 28, 2009
(86) PCT No.: PCT/JP2009/068535

§ 371 Date: May 17, 2011

(30) Foreign Application Priority Data
Dec. 19, 2008 (JP) 2008-324543

(51) Int. Cl. G05F 1/10

(52) U.S. Cl. 323/271

(57) ABSTRACT

To eliminate the problem that a magnetic deflection is caused in a transformer even when a coupled inductor converter is in a stationary operation state, provided is a DC-DC converter including a first series circuit portion formed by a first switching transistor, a first capacitor, a first inductor, and a second capacitor which are connected to a DC power in series in this order, and a second series circuit portion formed by a second switching transistor and a second inductor which are connected in series in this order, the second series circuit portion is connected in parallel to the first capacitor and the first inductor, and the first inductor and the second inductor constitute a coupled inductor having a plurality of windings and a common magnetic core.

### CROSS-REFERENCE TO RELATED APPLICATIONS

This is a national stage of the International Application No. PCT/JP2009/068535 filed on Oct. 28, 2009 and published in Japanese language.

### BACKGROUND OF THE INVENTION

1. Field of the Invention

The present invention relates to a DC-DC converter, and more particularly to a DC-DC converter in which a power loss can be reduced.

2. Description of the Conventional Art

In recent years, there is a tendency that a driving voltage and a driving current of an LSI such as a microprocessor or the like is made to be a low voltage and High current. There is a CPU or the like of which a maximum electric current consumption comes even to 100 A. In order to supply electric power to an LSI requiring the low voltage and High current, a DC-DC converter, which can convert an electric voltage of a power supply into a low voltage so as to output a High current, is employed.

As the DC-DC converter in which a switching loss is small, there has been proposed “multiple-phase type switching converter and control method thereof” (Japanese Unexamined Patent Publication No. 2006-223088).

The DC-DC converter described in Japanese Unexamined Patent Publication No. 2006-223088 is structured such that an added capacitor Ci is connected in series to a first main switching element Sa of a first step down type converter, and an input positive side terminal of a second step down type converter is connected to this connection point. In accordance with this structure, since the capacitor Ci divides an input power supply voltage Ni into halves, each of the converters operates by the half input voltage in appearance. Therefore, the switching loss is reduced.

On the other hand, in recent years, as described in U.S. Pat. No. 6,362,986, there has been proposed a DC-DC converter using a pair of coupled inductors structured such that a plurality of windings are wound around a common magnetic core.

### SUMMARY OF THE INVENTION

### Problem to be Solved by the Invention

### First Problem

However, in the DC-DC converter (hereinafter, refer to as “coupled inductor converter”) using the coupled inductor described in U.S. Pat. No. 6,362,986, there has been a problem that a magnetic deflection in transforming is generated even in a stationary operation state.

### Second Problem

On the other hand, in the DC-DC converter described in Japanese Unexamined Patent Publication No. 2006-223088, an unbalance is generated in an electric current flowing in each of circuit portions at a time of starting a circuit, due to an influence of the added capacitor Ci, and such a phenomenon that start of operation (coming to a stationary operation state) is delayed is confirmed. With regard to a performance of the CPU or the like, it is preferable that an unbalance of an electric current at a starting time is as small as possible, and start of operation is quick. Further, there has been a problem that an electric power consumption becomes great since an electric current flowing through an inductor fluctuates largely, so that a heavy load is applied to MOSFET constructing a circuit.

The present invention is made by taking the actual condition mentioned above into consideration, and intends to provide a DC-DC converter using a coupled inductor, in which a magnetic deflection in transforming is not generated in a stationary operation state. Further, the present invention intends to provide a DC-DC converter in which an unbalance of an electric current is small at a starting time of a circuit, and start of operation is quick.

### Means for Solving the Problem

The problems of the present invention can be solved by each of the following inventions.

The present invention provides a DC-DC converter converting a DC voltage into a different DC voltage, the DC-DC converter including a first series circuit portion in which a first switching transistor, a first capacitor, a first inductor, and a second capacitor are connected in series in this order, and a second series circuit portion which is connected in parallel to the first capacitor and the first inductor in the first series circuit portion, and in which a second switching transistor and a second inductor are connected in series in this order, wherein the first inductor and the second inductor are magnetically coupled to each other so as to construct a coupled inductor.

The present invention further provides a DC-DC converter converting a DC voltage into a different DC voltage, the DC-DC converter including a first series circuit portion in which a first switching transistor, a first capacitor, a first inductor, and a second capacitor are connected in series in this order, a second series circuit portion which is connected in parallel to the first capacitor and the first inductor in the first series circuit portion, and in which a second switching transistor, a third capacitor and a second inductor are connected in series in this order, and a third series circuit portion which is connected in parallel to the third capacitor and the second inductor in the second series circuit portion, and in which a third switching transistor and a third inductor are connected in series in this order, wherein at least two of the first to third inductors are magnetically coupled to each other so as to construct a coupled inductor.

The present invention further provides a DC-DC converter converting a DC voltage into a different DC voltage, the DC-DC converter including a first series circuit portion in which a first switching transistor, a first capacitor, a first inductor, and a second capacitor are connected in series in this order, a second series circuit portion which is connected in parallel to the first capacitor and the first inductor in the first series circuit portion, and in which a second switching transistor, a third capacitor and a second inductor are connected in series in this order, a third series circuit portion which is connected in parallel to the third capacitor and the second inductor in the second series circuit portion, and in which a third switching transistor, a fourth capacitor and a third inductor are connected in series in this order, and a fourth series circuit portion which is connected in parallel to the fourth capacitor and the third inductor in the third series circuit portion, and in which a fourth switching transistor and a fourth inductor are connected in series in this order, wherein at least two of the first to fourth inductors are magnetically coupled to each other so as to construct a coupled inductor.

In the DC-DC converter in accordance with the present invention, the structure may be made such that a plurality of circuits are connected in parallel, each of the circuits being constructed by the first series circuit portion and the second series circuit portion, and at least two of a plurality of inductors included in the circuits are magnetically coupled to each other so as to construct a coupled inductor.

Alternatively, in the DC-DC converter in accordance with the present invention, the structure may be made such that a plurality of circuits are connected in parallel, each of the circuits being constructed by the first series circuit portion, and one or more of the second series circuit portion, the third series circuit portion and the fourth series circuit portion, and at least two of a plurality of inductors included in the circuits are magnetically coupled to each other so as to construct a coupled inductor.

In the DC-DC converter in accordance with the present invention, the switching transistor is constructed by MOSFET.

In the DC-DC converter in accordance with the present invention constructed as mentioned above, the magnetic deflection in transforming is not generated in the stationary operation state, in spite of the DC-DC converter using the coupled inductor.

On the other hand, in the DC-DC converter in accordance with the present invention mentioned above, start of operation can be quickened as well as fluctuation of an electric current flowing in the inductors L1 and L2 at a starting time can be suppressed, and overloads of all the switching transistors can be suppressed. Further, increase of an electric power loss of the switch incidental to increase of an exciting current is prevented and breakage of the switch can be thereby prevented.

### Effect of the Invention

As described above, in accordance with the present invention, there is provided the DC-DC converter using the coupled inductor, wherein the magnetic deflection in transforming is not generated in the stationary operation state. Further, in accordance with another aspect of the present invention, there is provided the DC-DC converter in which the unbalance of the electric current is small at a starting time of the circuit, and the start of operation is quick.

Further, it is possible to prevent increase of the power loss of the switch incidental to the increase of the exciting current, to thereby prevent the switch from being broken.

### BRIEF EXPLANATION OF DRAWINGS

FIG. 1 is a circuit diagram showing a structure of a DC-DC converter in accordance with an embodiment of the present invention;

FIGS. 2(A) to 2(D) are a circuit diagram of a conventional converter, a circuit diagram of a converter in accordance with the present embodiment and charts expressing results of simulation;

FIGS. 3(A) to 3(D) are circuit diagrams of a circuit where a coupled inductor is provided and a capacitor C1 is deleted, and a circuit in accordance with the present invention, and charts showing results of simulation for each of the circuits;

FIGS. 4(A) to 4(D) are charts showing results of simulation of Voltages at a point A and a point B and exciting currents of the inductor in the cases of T1=T3 and T1>T3;

where ON times of the switches Q1 and Q3 are denoted by T1 and T3 respectively,

FIGS. 5(A) to 5(D) are charts showing results of simulation of exciting currents of the inductor in the cases of T1=T3 and T1>T3;

FIG. 6 is a circuit diagram showing a structure of a DC-DC converter in accordance with another embodiment of the present invention;

FIG. 7 is a circuit diagram showing a structure of a DC-DC converter in accordance with another embodiment of the present invention;

FIG. 8 is a circuit diagram showing a structure of a DC-DC converter in accordance with another embodiment of the present invention;

FIG. 9 is a circuit diagram showing a structure of a DC-DC converter in accordance with another embodiment of the present invention;

FIG. 10 is a circuit diagram showing a structure of a DC-DC converter in accordance with another embodiment of the present invention; and

FIG. 11 is a circuit diagram showing a structure of a DC-DC converter in accordance with another embodiment of the present invention.

### DETAILED DESCRIPTION OF PREFERRED EMBODIMENT

A description will be in detail given below of a best mode for executing a DC-DC converter in accordance with the present invention with reference to the accompanying drawings.

<Construction>

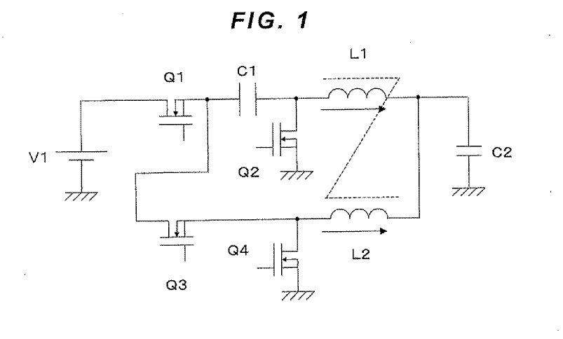

A description will be given of a construction of a DC-DC converter in accordance with an embodiment of the present invention with reference to the accompanying drawings. FIG. 1 is a circuit diagram showing a construction of the DC-DC converter in accordance with the present embodiment.

As shown in FIG. 1, the DC-DC converter in accordance with the present embodiment is constructed by a DC power supply V1, switching transistors Q1, Q2, Q3 and Q4, capacitors C1 and C2, and inductors L1 and L2 constituted by a plurality of windings and a common magnetic core so as to form a coupled inductor.

The switching transistor Q1, the capacitor C1, the inductor L1 and the capacitor C2 which are connected in series are connected to the DC power supply V1. The switching transistor Q2 is connected between a node of the capacitor C1 and the inductor L1, and a GND.

The switching transistor Q3 and the inductor L2, which are connected in series, are connected in parallel to the capacitor C1 and the inductor L1. The switching transistor Q4 is connected between a node of the switching transistor Q3 and the inductor L2, and the GND.

The switching transistors Q1, Q2, Q3 and Q4 can be MOSFET, however, are not limited to this, but can be other switching transistors.

In this case, the inductors L1 and L2 may be magnetically coupled to each other without having any common magnetic core. In the following description, an expression “having a common magnetic core” is used in both the case that a plurality of inductors constructing the coupled inductor have a common magnetic core, and the case that they are only magnetically coupled to each other.

<Operation>

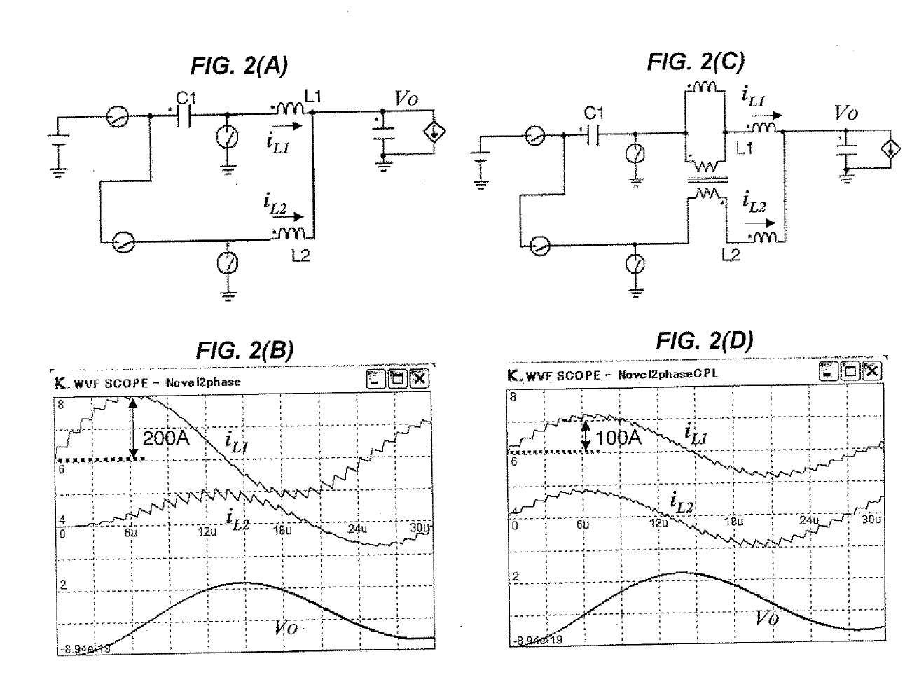

Next, a description will be given of an operation of the DC-DC converter in accordance with the present embodiment with reference to FIGS. 2(A) to 5(D).

First of all, a description will be given with reference to FIGS. 2(A) to 2(D). FIGS. 2(A) to 2(D) are a circuit diagram of a conventional converter, a circuit diagram of a converter in accordance with the present embodiment and charts expressing results of simulation.

FIG. 2(A) is a circuit diagram of a converter circuit described in Japanese Unexamined Patent Publication No. 2006-223088. FIG. 2(B) expresses a result obtained by simulating an electric current flowing through L1 and L2 of the converter circuit in FIG. 2(A). As is described in Japanese Unexamined Patent Publication No. 2006-223088, since the capacitor C1 divides a voltage of the DC power supply V1, the converter operates by a half of the voltage of the DC power supply V1. Accordingly, it is possible to make an output current ripple small.

As shown in FIG. 2(B), it operates in such a manner that electric currents iL1 and iL2 flowing in L1 and L2 fluctuate greatly at a starting time. In FIG. 2(B), iL1 shows a peak current of 20 A. In other words, in the case that L1 and L2 are normal inductors which do not construct the coupled inductor, the electric currents actually flowing in L1 and L2 are fluctuated greatly at a starting time, and overloads are accordingly applied to all the switching transistors. Therefore, there is a risk that all the switching transistors are broken.

As a result of a study made devotedly by the inventors, it has been found that the converter operates so as to make the electric currents flowing in the inductors L1 and L2 greatly fluctuate due to the influence of the capacitor C1, at a starting time. This is apparent from the fact that any fluctuation is not generated in the circuit in which the capacitor C1 is omitted, in the circuit in accordance with the present embodiment.

FIG. 2(C) is a circuit diagram of the converter circuit in accordance with the present embodiment. FIG. 2(D) shows a result obtained by simulating an electric current flowing in L1 and L2 of the converter circuit in accordance with the present embodiment. As shown in FIG. 2(C), the inductors L1 and L2, which are constructed by a plurality of windings and a common magnetic core so as to form a coupled inductor is used in the present embodiment. Accordingly, if the electric current of one side inductor in the coupled inductor is increased, another side inductor is affected to operate so as to make the electric current increase. Accordingly, they are affected by each other, suppress the fluctuation of the electric current, and operate in such a manner as to quickly end the fluctuation of the electric current.

Actually, as shown in FIG. 2(D), a peak current of iL1 is 100 A which is a half in comparison with FIG. 2(B).

As mentioned above, in the DC-DC converter in accordance with the present embodiment, it is possible to suppress the overloads of all the switching transistors so as to prevent them from being broken, as well as it is possible to suppress the fluctuation of the electric currents flowing in the inductors L1 and L2 at a starting time.

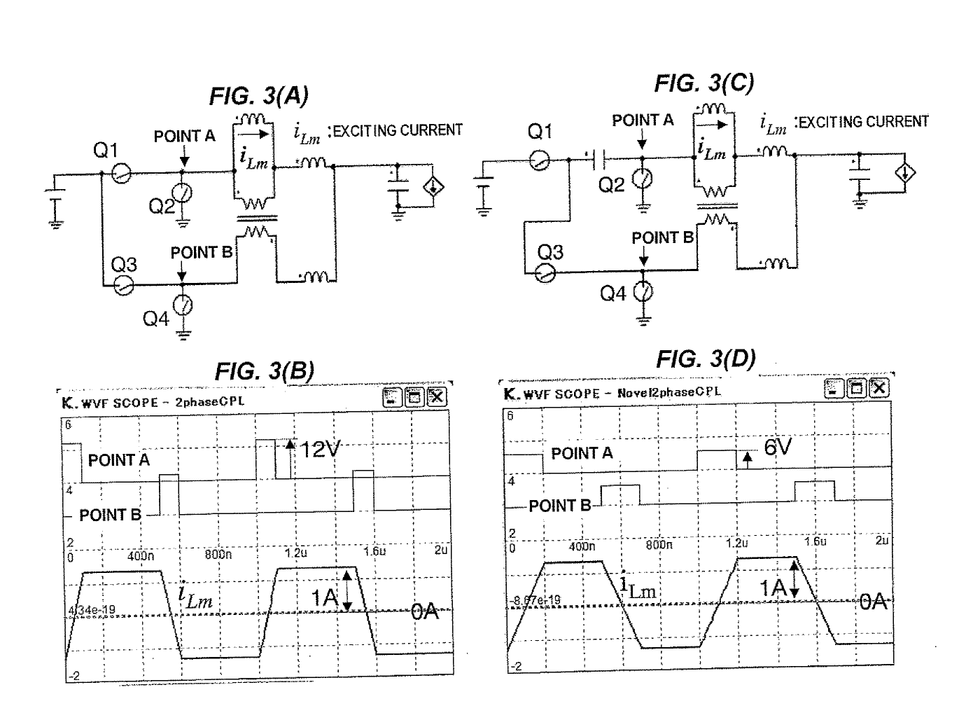

Next, a description will be given of another effect of the DC-DC converter in accordance with the present embodiment. FIGS. 3(A) to 3(D) are circuit diagrams of a circuit provided with a coupled inductor while the capacitor C1 being deleted, and a circuit in accordance with the present embodiment, and charts showing results of simulation in the respective circuits.

As shown in FIG. 3(A), in the circuit in which the capacitor C1 is deleted, and the inductors L1 and L2 are constructed as the coupled inductor, an electric voltage at a point A and a point B is V at a time when the power supply voltage is 12 V, as shown in FIG. 3(B). This is because the capacitor C1 is not provided, and the electric voltage is not divided by the capacitor C1.

On the contrary, in the circuit in accordance with the present embodiment shown in FIG. 3(C), since the power supply voltage is divided by the capacitor C1 as shown in FIG. 3(D), the electric voltage at the point A and the point B becomes 6 V corresponding to a half of the electric voltage shown by FIG. 3(B).

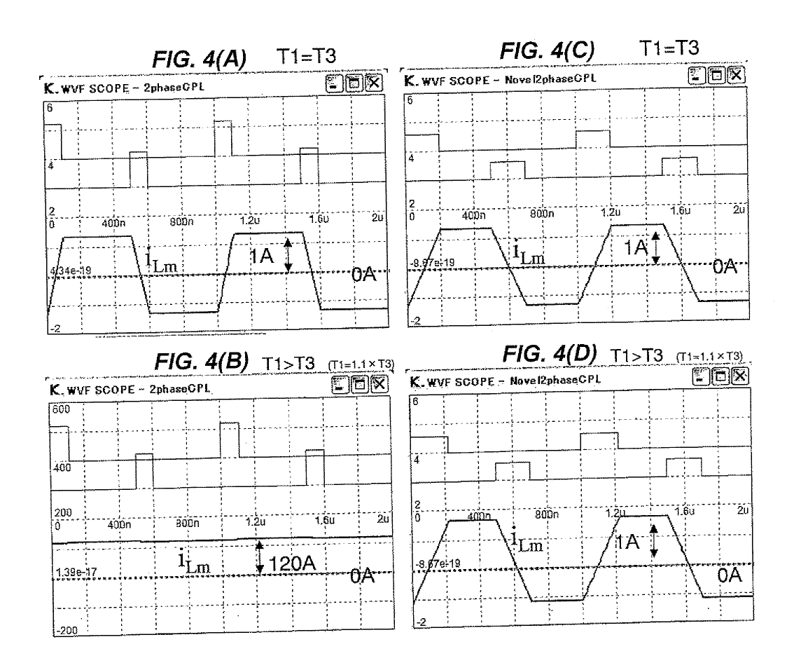

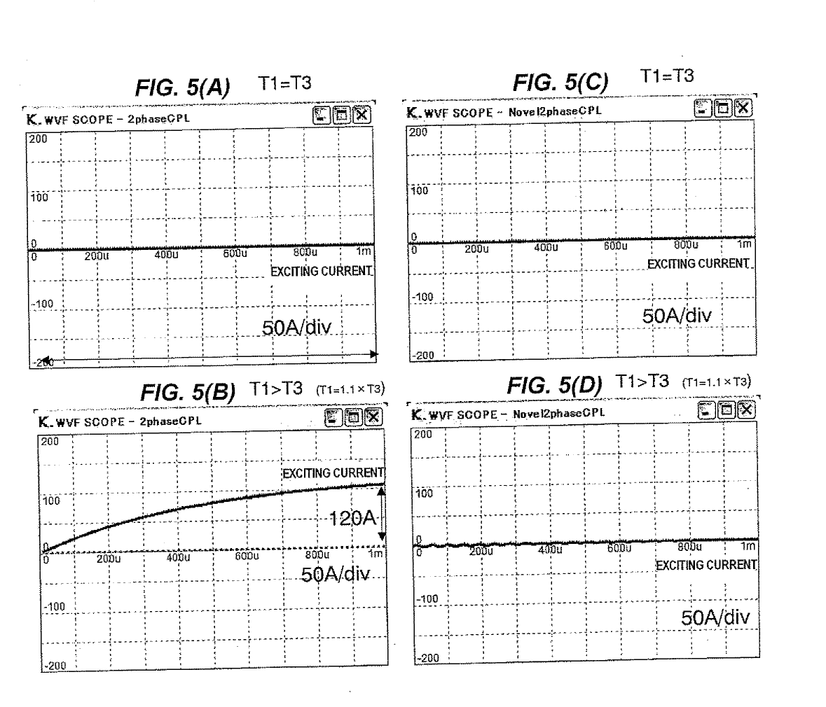

Then, a description will be given of an operation of the circuit in each of the case of T1=T3 and the case of T1>T3, with reference to FIGS. 4(A) to 4(D) and 5(A) to 5(D). FIGS. 4(A) to 4(D) are charts showing the Voltages at the point A and the point B in the case of T1=T3 and the case of T1>T3, and results of simulation of exciting currents of the inductor, and FIG. 5(A) to 5(D) are charts showing a results of simulation of exciting currents of the inductor in the case of T1=T3 and the case of T1>T3.

FIG. 4(A), FIG. 4(b), FIG. 5(A) and FIG. 5(B) are charts showing results of simulation of the circuits in which the capacitor C1 is deleted, and the inductors L1 and L2 are constructed as the coupled inductor, and FIG. 4(C), FIG. 4(D), FIG. 5(C) and FIG. 5(D) are charts showing results of simulation of the circuit in accordance with the present embodiment.

As shown in FIG. 4(A) and FIG. 4(C), in the case of T1=T3, the peaks of the exciting currents iLm indicate the same value of 1 A in the both. However, in the case of T1>T3, the peak of the exciting current iLm is 120 A, as shown in FIG. 4(B), in the circuit in which the capacitor C1 is deleted. As a result of a study devotedly made by the inventors, it has been known that this is caused by saturation of the core of the inductors L1 and L2 constructing the coupled inductor.

On the contrary, in the circuit in accordance with the present embodiment, as shown in FIG. 4(D), the peak of the exciting current iLm does not change and is 1 A even in the case of T1>T3.

Describing further, since the Voltages at the point A and the point B are the same as the power supply voltage in the circuit provided with no capacitor C1 shown in FIG. 4(A), a value obtained by the formula of power supply voltage×time is different between the point A and the point B, if the ON time is different between Q1 and Q3. If the values obtained by the formula of power supply voltage×time for the inductors L1 and L2 are different, the core is saturated and the exciting currents flowing in the inductors L1 and L2 are widely increased. Accordingly, the power losses are increased in all the switches, and there is a risk that heavy loads are applied to the switches.

On the contrary, in the circuit in accordance with the present embodiment shown in FIG. 4(C), since the capacitor C1 is provided, it is possible to adjust the value obtained by the formula of power supply voltage×time to a fixed value on the basis of changes of the Voltages applied to the point A and the point B, even if the ON times of Q1 and Q3 are different. Therefore, since the values obtained by the formula of power supply voltage×time for the inductors L1 and L2 are not different, the core is not saturated, and the exciting current hardly fluctuates.

In other words, the circuit in accordance with the present embodiment can be said to be a circuit in which the fluctuation of the exciting current is widely reduced by adding of the capacitor C1 in the DC-DC converter having the coupled inductor. Accordingly, in the circuit in accordance with the present embodiment, it is possible to obtain such an operational effect that the magnetic deflection in transforming is not generated in the stationary operation state.

Seeing about this in accordance with a simulation, as shown in FIG. 5(A) and FIG. 5(C), in the case of T1=T3, the exciting current does not increase in both a result of simulation (a) of the circuit provided with no capacitor C1, and a result of simulation (c) of the circuit in accordance with the present embodiment. However, in the case of T1>T3, the exciting current widely increases in a result of simulation (b) of the circuit provided with no capacitor C1. On the contrary, the exciting current does not increase in a result of simulation (d) of the circuit in accordance with the present embodiment.

### Other Embodiments

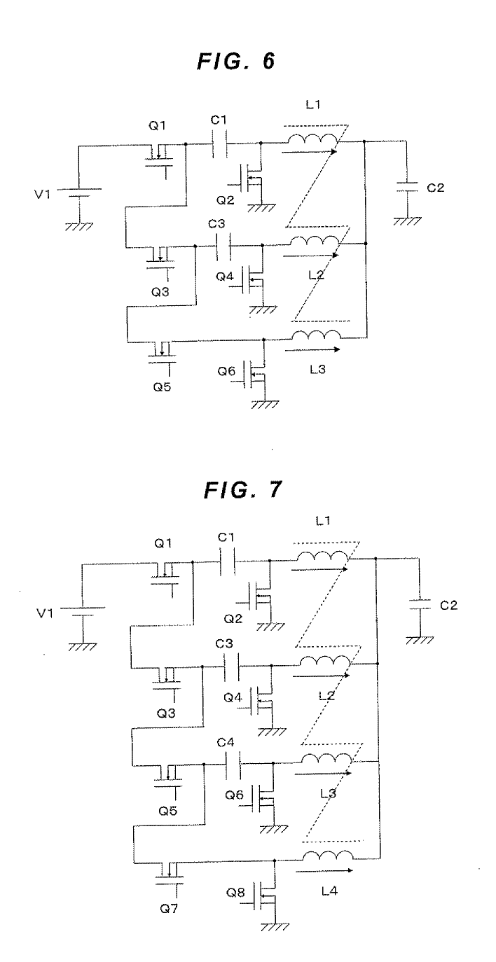

Subsequently, a description will be given of a structure of a DC-DC converter in accordance with other embodiments of the present invention with reference to the accompanying drawings. FIG. 6 is a circuit diagram showing a structure of the DC-DC converter in accordance with another embodiment of the present invention.

As shown in FIG. 6, the DC-DC converter in accordance with the present embodiment is structured such that a switching transistor Q5 and an inductor L3, which are connected in series, are connected in parallel to the capacitor C3 and the inductor L2, in addition to the circuit of the DC-DC converter shown in FIG. 1. Further, a switching transistor Q6 is connected between a node of the switching transistor Q5 and the inductor L3, and the GND. The inductors L1, L2 and L3 have a common magnetic core, thereby constructing the coupled inductor.

In other words, the DC-DC converter in accordance with the present embodiment can be said to be a multiple-phase (three-phase) circuit in which a portion corresponding to the lower row of the parallel circuit in the circuit of the DC-DC converter shown in FIG. 1 is further connected in parallel to the lower side thereof.

The DC-DC converter in accordance with the present embodiment constructed by the multiple-phase circuit as mentioned above has the same circuit characteristic as that of the DC-DC converter shown in FIG. 1 mentioned above, and has such an operational effect that start of operation is quick at a starting time, and a magnetic deflection in a stationary operation time is extremely small.

In this case, the circuit is not limited to the example shown in FIG. 6, but may be constructed by a multiple-phase circuit having four or more rows in which an optional number of the parallel circuits are further connected to the lower side.

FIG. 7 is a circuit diagram showing a structure of a DC-DC converter in which the circuit is formed to have further multiple phases than the DC-DC converter in accordance with the embodiment shown in FIG. 6. As shown in FIG. 7, the DC-DC converter in accordance with the present embodiment is structured such that a switching transistor Q7 and an inductor L4, which are connected in series, are connected in parallel to the capacitor C4 and the inductor L3, in addition to the circuit of the DC-DC converter shown in FIG. 6. Further, a switching transistor Q8 is connected between a node of the switching transistor Q7 and the inductor L4, and the GND. The inductors L1, L2, L3 and L4 have a common magnetic core, thereby constructing a coupled inductor.

In other words, the DC-DC converter in accordance with the present embodiment can be said to be a multiple-phase (four-phase) circuit in which two rows of a portion corresponding to the lower row of the parallel circuit in the circuit of the DC-DC converter shown in FIG. 1 are further connected in parallel to the lower side thereof.

It is possible to construct the circuit such as to have further multiple phases, by further connecting the switching transistor and the coupled inductor, which are connected in series, and the switching transistor between a node thereof and the GND, to the lower position, in the same manner.

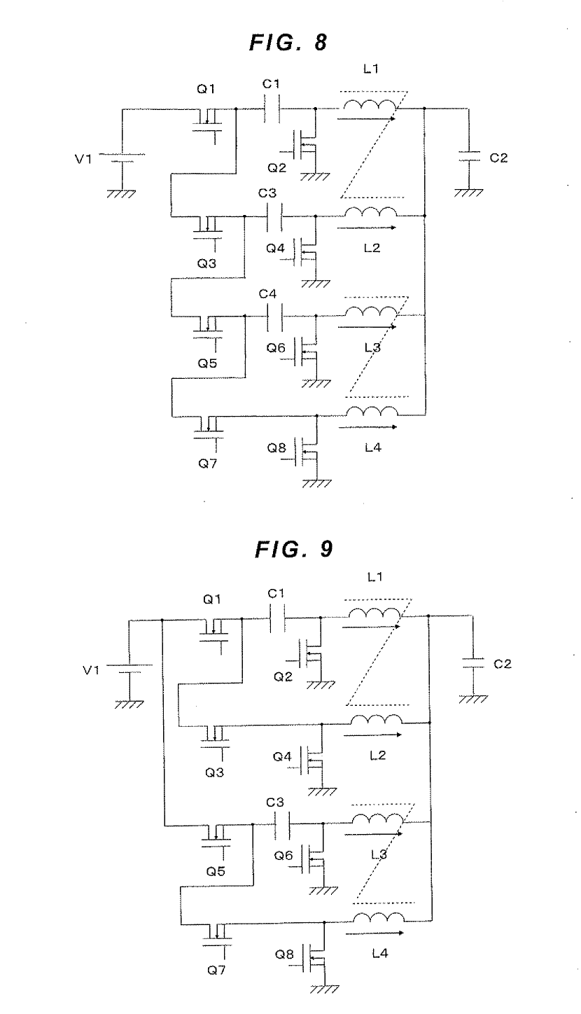

FIG. 8 is a circuit diagram showing a structure of a DC-DC converter corresponding to a modified embodiment of the circuit structure in the DC-DC converter in accordance with the embodiment shown in FIG. 7.

As shown in FIG. 8, the DC-DC converter in accordance with the present embodiment has the same circuit structure as the circuit of the DC-DC converter shown in FIG. 7, however, the inductors L1 to L4 do not integrally construct a coupled inductor, but a set of the inductors L1 and L2, and a set of the inductors L3 and L4 construct coupled inductors respectively.

In addition, the circuit can be structured such that two or more sets of optional number of inductors construct coupled inductors.

FIG. 9 is a circuit diagram showing a structure of a DC-DC converter corresponding to a modified embodiment of the circuit structure in the DC-DC converter in accordance with the embodiment shown in FIG. 1.

As shown in FIG. 9, the DC-DC converter in accordance with the present embodiment is structured such that a circuit having an equivalent structure to the circuit portion constructed by the switching transistors Q1 to Q4, the capacitor C1, and the coupled inductors L1 and L2 is connected in parallel to the circuit portion, between the DC power supply V1 in the circuit of the DC-DC converter shown in FIG. 1 and the grounded capacitor C2. In the present embodiment, the inductors L1 to L4 do not integrally construct a coupled inductor, but a set of the inductors L1 and L2, and a set of the inductors L3 and L4 construct coupled inductors respectively.

In addition, the circuit may be constructed in such a manner that two or more sets of optional number of inductors construct coupled inductors.

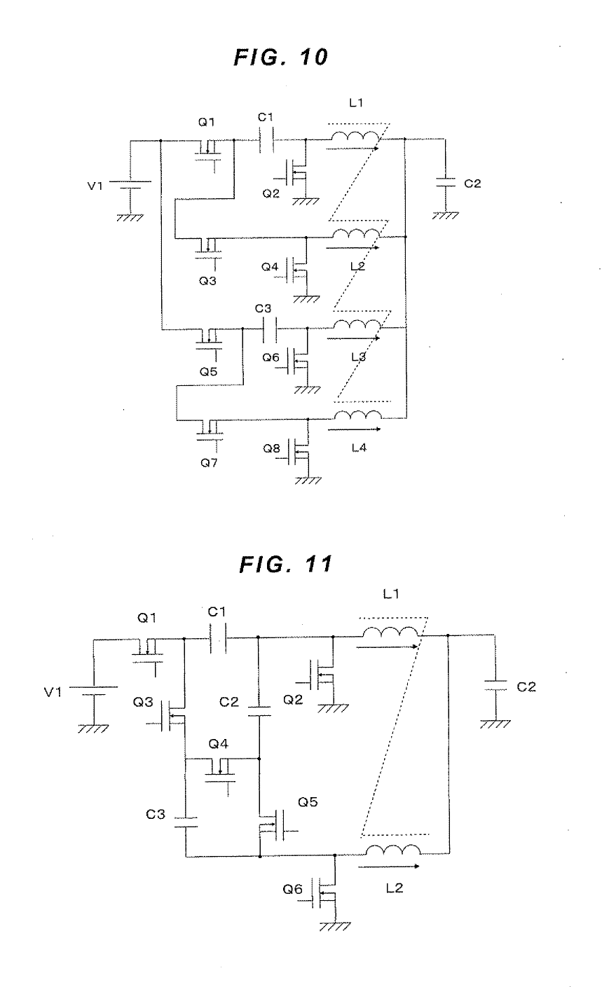

FIG. 10 is a circuit diagram showing a structure of a DC-DC converter corresponding to a modified embodiment of the circuit structure in the DC-DC converter in accordance with the embodiment shown in FIG. 9.

As shown in FIG. 10, the DC-DC converter in accordance with the present embodiment has the same circuit structure as the circuit of the DC-DC converter shown in FIG. 9, except the inductors L1 to L4 integrally constructing a coupled inductor.

FIG. 11 is a circuit diagram showing a structure of a DC-DC converter in accordance with further another embodiment of the present invention.

As shown in FIG. 11, the DC-DC converter in accordance with the present embodiment is structured such that two inductors are omitted in the circuit of the four-phase DC-DC converter shown in FIG. 8, and the circuit structure is made compact.

The description is given above of the DC-DC converter in accordance with the present invention by showing the particular embodiments, however, the present invention is not limited to them. Those skilled in the art can make various changes and improvements to the structures and the functions of the DC-DC converter in the embodiments mentioned above, within the range which does not depart from the scope of the present invention.

### INDUSTRIAL APPLICABILITY

Since the DC-DC converter in accordance with the present invention is achieved by the switching transistor, the capacitor, the coupled inductor and the like, and the DC voltage conversion is achieved by using the electronic parts mentioned above, it corresponds to a technical idea utilizing the natural law, and can be utilized in every field using the LSI such as the CPU or the like requiring the low voltage and High current.

1. A DC-DC converter converting a DC voltage into a different DC voltage into a different DC voltage, the DC-DC converter comprising:
a first series circuit portion in which a first switching transistor, a first capacitor, a first inductor, and a second capacitor are connected in series in this order; and
a second series circuit portion which is connected in parallel to said first capacitor and said first inductor in said first series circuit portion, and in which a second switching transistor and a second inductor are connected in series in this order,
wherein said first inductor and said second inductor are magnetically coupled to each other so as to construct a coupled inductor.

2. A DC-DC converter converting a DC voltage into a different DC voltage, the DC-DC converter comprising:
a first series circuit portion in which a first switching transistor, a first capacitor, a first inductor, and a second capacitor are connected in series in this order;
a second series circuit portion which is connected in parallel to said first capacitor and said first inductor in said first series circuit portion, and in which a second switching transistor, a third capacitor and a second inductor are connected in series in this order; and
a third series circuit portion which is connected in parallel to said third capacitor and said second inductor in said second series circuit portion, and in which a third switching transistor and a third inductor are connected in series in this order,
wherein at least two of said first to third inductors are magnetically coupled to each other so as to construct a coupled inductor.

3. A DC-DC converter converting a DC voltage into a different DC voltage, the DC-DC converter comprising:
a first series circuit portion in which a first switching transistor, a first capacitor, a first inductor, and a second capacitor are connected in series in this order;
a second series circuit portion which is connected in parallel to said first capacitor and said first inductor in said first series circuit portion, and in which a second switching transistor, a third capacitor and a second inductor are connected in series in this order;
a third series circuit portion which is connected in parallel to said third capacitor and said second inductor in said second series circuit portion, and in which a third switching transistor, a fourth capacitor and a third inductor are connected in series in this order; and
a fourth series circuit portion which is connected in parallel to said fourth capacitor and said third inductor in said third series circuit portion, and in which a fourth switching transistor and a fourth inductor are connected in series in this order,
wherein at least two of said first to fourth inductors are magnetically coupled to each other so as to construct a coupled inductor.

4. A DC-DC converter as claimed in claim 1, wherein a plurality of circuits are connected in parallel, each of the circuits being constructed by said first series circuit portion and said second series circuit portion, and wherein at least two of a plurality of inductors included in said circuit are magnetically coupled to each other so as to construct a coupled inductor.

5. A DC-DC converter as claimed in claim 2, wherein a plurality of circuits are connected in parallel, each of the circuits being constructed by said first series circuit portion, and one or more of said second series circuit portion, said third series circuit portion and said fourth series circuit portion, and wherein at least two of a plurality of inductors included in said circuit are magnetically coupled to each other so as to construct a coupled inductor.

6. A DC-DC converter as claimed in claim 1, wherein said switching transistor is constructed by MOSFET.

7. A DC-DC converter as claimed in claim 3, wherein a plurality of circuits are connected in parallel, each of the circuits being constructed by said first series circuit portion, and one or more of said second series circuit portion, said third series circuit portion and said fourth series circuit portion, and wherein at least two of a plurality of inductors included in said circuit are magnetically coupled to each other so as to construct a coupled inductor.

8. A DC-DC converter as claimed in claim 2, wherein said switching transistor is constructed by MOSFET.

9. A DC-DC converter as claimed in claim 3, wherein said switching transistor is constructed by MOSFET.

10. A DC-DC converter as claimed in claim 4, wherein said switching transistor is constructed by MOSFET.

11. A DC-DC converter as claimed in claim 5, wherein said switching transistor is constructed by MOSFET.
